(19) United States
(12) Patent Application Publication
(10) Pub. No.: US 2025/0117411 A1
(43) Pub. Date: Apr. 10, 2025

(54) Generic Conversational Chatbot Handoff to Domain-Specific Chatbots

(71) Applicant: The Toronto-Dominion Bank, Toronto (CA)

(72) Inventor: Shahzad Mohammed, Ontario (CA)

(21) Appl. No.: 18/480,963

(22) Filed: Oct. 4, 2023

(51) Int. Cl. G06F 16/332; H04L 51/02; H04L 67/02; H04L 67/30

(52) U.S. Cl. CPC G06F 16/3329; H04L 51/02; H04L 67/02; H04L 67/30

(57) ABSTRACT

The present disclosure relates to computer-implemented methods, software, and systems for transferring contexts from a generic chatbot to a domain-specific chatbot. In one example, a registration at a first conversational interface is received that identifies at least one endpoint associated with a first entity that is separate from the first conversational interface and is associated with a domain-specific conversational interface. The first conversational interface can interact with a user through a natural language search interaction. The interface can identify at least one response associated with one of the at least one endpoints associated with the first entity, and can provide the response and an interactive response associated with initiating a transfer of the interaction from the first conversational interface to a domain-specific conversational interface of the first entity. Once accepted, the interaction is transferred to the first entity and its domain-specific conversational interface.

### TECHNICAL FIELD

The present disclosure relates to computer-implemented methods, software, and systems for transferring contexts from a generic chatbot or conversational search engine to a domain-specific chatbot or conversational search engine to preserve and transfer the context of the initial interaction to the suggested interaction with a specific entity associated with the domain-specific chatbot.

### BACKGROUND

A chatbot is a software application or web interface that aims to mimic human conversation through text or voice interactions. Data-driven and predictive (conversational) chatbots may be referred to as virtual assistants or digital assistants, and may be more sophisticated and interactive than prior versions of simple, task-oriented chatbots. Chatbots can be contextually aware and can leverage natural-language understanding (NLU), natural-language processing (NLP), and machine learning (ML) to learn as they go. Chatbots and their conversational interfaces can be used for web searching, customer service, customer support, and other sorts of virtual assistant tasks.

### SUMMARY

The present disclosure generally relates to systems, software, and computer-implemented methods for transferring contexts from a generic chatbot or conversational search engine to a domain-specific chatbot or conversational search engine.

A first example method includes receiving a registration at a first conversational interface, where the registration identifies at least one endpoint associated with a first entity. The first entity is separate from the first conversational interface, and can be associated with its own domain-specific conversational interface. The at least one endpoint associated with the first entity represents a connection to the domain-specific conversational interface. The first conversational interface can interact with a first user through a natural language search interaction. During the interaction, the first conversational interface can identify at least one response associated with one of the at least one endpoints associated with the first entity. The first conversational interface can then provide for presentation the at least one identified response and an interactive suggestion or recommendation to initiate a transfer of the natural language search interaction from the first conversational interface to a domain-specific conversational interface of the first entity. In response to identifying a user interaction from the first user indicating an intent to transfer, the natural language search interaction is transferred from the first conversational interface to domain-specific conversational interface associated with the first entity.

Implementations can optionally include one or more of the following features.

In some implementations, registering the at least one endpoint associated with the first entity at the first conversational interface comprises generating a search configuration profile associated with the first entity, where the search configuration profile is associated with at least one search result or response and the at least one endpoint associated with the first entity. Additionally, at least one of a disclosure, a set of terms and conditions, or a privacy statement is associated with the first entity.

In some of those instances, transferring the natural language search interaction can include additional operations. The first conversational interface can obtain information from the search configuration profile associated with the first entity based on the at least one identified response, and a set of context associated with the natural language search interaction between the first user and first conversational interface can be identified. The first conversational interface can then generate a transfer UI, where the transfer UI is associated with the transfer of the natural language search interaction from the first conversational interface to domain-specific conversational interface associated with the first entity. The transfer UI can include or present at least a portion of the obtained information from the search configuration profile and at least a portion of the identified set of context associated with the natural language search interaction. The first conversational interface can then provide the transfer UI for presentation to the first user.

In some of those implementations, as well as others, the transfer UI can include selectable UI elements associated with the at least a portion of the identified set of context. The selectable UI elements are selectable by the first user to indicate which of the at least a portion of the identified set of context to provide to the domain-specific conversational interface when performing the transfer.

In some of those implementations, as well as others, the at least a portion of the identified set of context comprises at least one of browser settings associated with the browser of the first user, location information associated with the first user as determined by the first conversational interface, a full chat transcript from the interactions between the first conversational interface and the first user, or a summary of the interactions between the first conversational interface and the first user. In some implementations, the identified set of context includes the full chat transcript, and the full chat transcript is included for review in the transfer UI.

In some instances, transferring the natural language search interaction from the first conversational interface to the domain-specific conversational interface associated with the first entity comprises identifying selections of the first user from the at least the portion of the identified set of context, incorporating the identified selections of the first user into the transfer to the domain-specific conversational interface, and performing the transfer from the first conversational interface to the domain-specific conversational interface associated with the first entity.

In some implementations, performing the transfer from the first conversational interface to the domain-specific conversational interface associated with the first entity includes transmitting an HTTPS POST request to the at least one endpoint associated with the first entity. The HTTPS POST request includes the identified selections of the first user, and the at least one endpoint associated with the first entity is operable to connect to the domain-specific conversational interface of the first entity.

In some implementations, performing the transfer from the first conversational interface to the domain-specific conversational interface associated with the first entity comprises transmitting an HTTPS GET request to the at least one endpoint associated with the first entity. The HTTPS GET request provides a unique identifier to the at least one endpoint, where the unique identifier is capable of being used by the first entity to access the identified selections of the first user from the first conversational interface via a backchannel connection. Further, the at least one endpoint associated with the first entity is operable to connect to the domain-specific conversational interface of the first entity.

In some instances, receiving the registration at the first conversational interface comprises receiving registrations for a plurality of endpoints, where the plurality of endpoints associated with the first entity and at least one other entity. Each of the plurality of endpoints are associated with entities separate from the first conversational interface, and each of the entities is associated with at least one corresponding domain-specific conversational interface. Each of the plurality of endpoints are operable to connect with a corresponding domain-specific conversational interface.

Similar operations and processes associated with each example system can be performed in different systems comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations can also be contemplated. Additionally, similar operations can be associated with or provided as computer-implemented software embodied on tangible, non-transitory media that processes and transforms the respective data, some or all of the aspects can be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

The techniques described herein can be implemented to achieve the following advantages. For example, in some cases, the techniques described herein can improve user experience and sharing of information between chatbots, combining the context of an initial user interaction with a first chatbot with an experience at a later, second chatbot associated with a domain-specific conversational AI or interface. In doing so, a user's time and effort in finding the second chatbot through a conversational interaction can be used in improving the later experience with the second chatbot associated with a different entity. Further, the transfer of the experience can be essentially seamless, while allowing the user full control over the amount and type of information being shared with the newly identified entity. Further, sharing user contexts and chat histories between generic and domain-specific conversational AIs allow generic and domain-specific conversational AIs to be enhanced, taking advantage of the search recommendations to place the users with relevant entities, without losing the work and context it took to arrive at those domain-specific entities.

### DESCRIPTION OF DRAWINGS

FIG. 1 is a block diagram of an example environment for transferring contexts from a generic chatbot to a domain-specific chatbot.

FIGS. 2A-C illustrates an example swim lane diagram between a browser, a generic chatbot, and a domain-specific chatbot to allow for transferring context from the generic chatbot to the domain-specific chatbot.

FIG. 3 is an example user interface (UI) for transferring context from a generic chatbot to a domain-specific chatbot, where the user is able to select the type of information and context to be shared from the generic chatbot to the domain-specific chatbot.

FIG. 4 is a flow diagram of an example method for transferring contexts from a generic chatbot to a domain-specific chatbot.

### DETAILED DESCRIPTION

The present disclosure generally relates to computer-implemented methods, software, and systems for transferring contexts from a generic chatbot or conversational search engine to a domain-specific chatbot or conversational search engine to preserve and transfer the context of the initial interaction to the suggested interaction with a specific entity associated with the domain-specific chatbot. For example, a user may begin an interaction via their web browser (or a specific application) with ChatGPT, Bing Chat, and/or other conversational search engines. During those interactions, a user's conversation may result in the chatbot or conversational search engine to provide specific answers and recommendations, including one or more relevant to a particular business, entity, or organization. To provide further interaction with users, those businesses, entities, and/or organizations can register particular end points with the generic or non-domain-specific chatbot, which can allow links or connections to the domain-specific conversational interfaces specific to those businesses, entities, and/or organizations to be identified, suggested, and accessed by the generic chatbot users. In accessing those domain-specific chatbots, users can have their search context and history from their initial interaction transferred, in whole or in part, to the domain-specific chatbot, allowing prior questions and context to be included in the initial state of the domain-specific chatbot.

In one example, a chat-based search interaction, such as through Bing Chat, allows for chat-based searches and interactions with the intelligent, but non-domain-specific, chatbot. A query or prompt can be submitted by a user in natural language, and responsive natural language results may be provided. In some instances, an OpenAI model can be used in the background with the search technology to allow for deeper and more meaningful results, particularly as compared to prior generations of searches, such as where a list of pages and recommend sites may be provided. As performed in the past, the search is based on relevance to key words in a search, interpreting the query, and providing the list to users.

In the current solution, a user can interact with the generic chatbot or other AI-based interactive search, where, as users work through and interact with the chatbot, one or more recommendations for a particular business, entity, or organization can be suggested or responsive as relevant to the search or discussion. In these instances, certain service and data providers can associate their services to potential recommendation points with the generic chatbot. As particular end point recommendations are determined, the recommendations can be tied to particular entry points to provider-specific systems, and particularly, to provider-specific, or domain-specific, chatbots or conversational interfaces. For example, as discussions with the generic chatbot relate to financial aspects or needs, the determined endpoint by the generic chatbot may be related to opening a financial account, or to starting a discussion with a financial institution or representative. With a connected endpoint, the chatbot can provide, to the user, an interactive link to the relevant financial institution site, or to a financial institution-specific chatbot. If the user interacts with the link, a handoff from the generic chatbot to the provider-or domain-specific chatbot can be initiated, where context and other details from the generic chatbot discussion can be provided to the provider-specific chatbot, and the financial institution's chatbot can continue the discussion to perform financial-specific answers and operations. To preserve user information and avoid unnecessary or unwanted sharing of information from the generic, or initial, chatbot, a full disclaimer and clear indication of the potential transfer can be presented, including the ability of the user to identify, modify, or otherwise select what contextual information is to be provided to the financial system as the provider-specific chat begins. In some instances, the user may choose to provide no information to the provider-specific chatbot, while in others, all, or some, of the contextual information and chat history can be provided.

Among other benefits, the present solution allows generic chatbots to be enhanced and made more useful by creating relevant links to domain-specific chatbots where ongoing conversations can be handed off to domain-specific chatbots that can provide provider-specific answers and assistant to the users without having to re-enter their original interactions with the generic chatbot. By pre-registering certain topics, recommendations, and other information, entities associated with domain-specific chatbots can create associations that can be used to link chatbots and allow for handoffs to occur. In doing so, the work done to reach the recommendation or link does not need to be discarded as the user connects with the domain-specific chatbot. At the same time, the user has control in managing what information from the initial chat interaction will be shared with the domain-specific chatbot, and can specify that information to be shared via a clear and informative transfer UI, which can includes disclaimers and relevant information about the transfer, as well, and clearly indicate that the transfer is moving to a domain-specific chatbot.

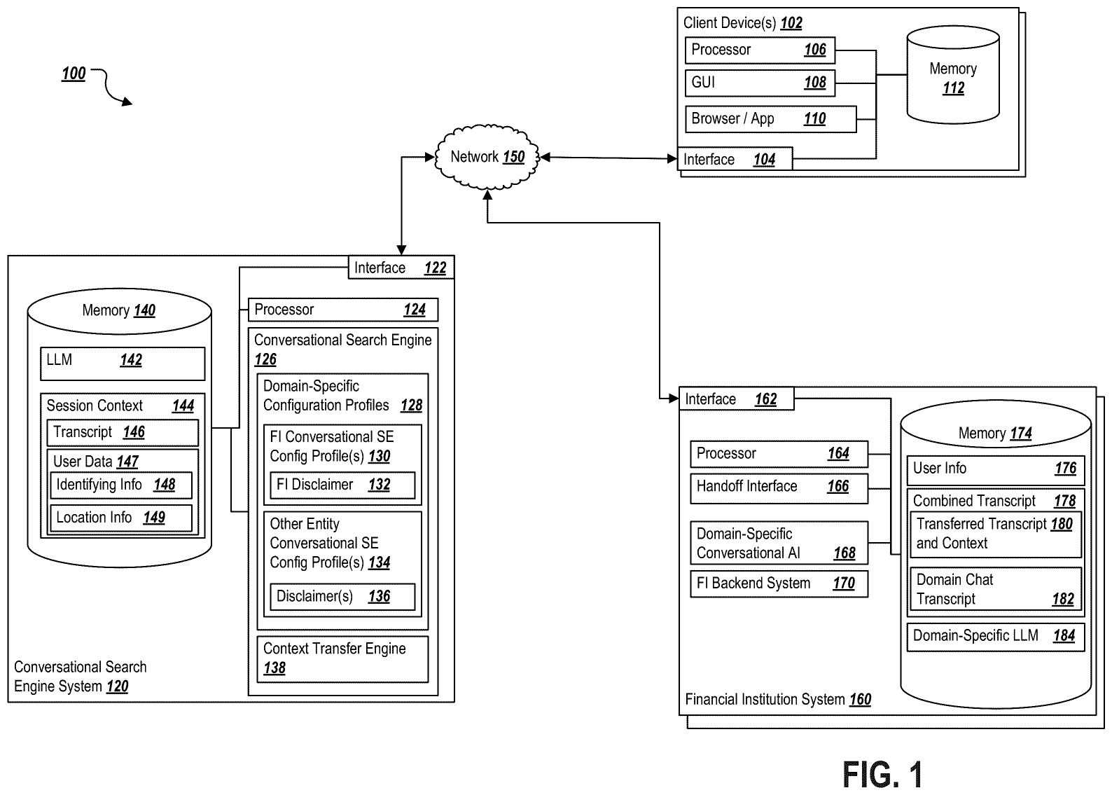

Turning to the illustrated example implementation, FIG. 1 is a block diagram an example environment for transferring contexts from a generic chatbot to a domain-specific chatbot. One example of such a transfer may be from a general chat-based search engine, such as Microsoft's Bing Chat or Google's Bard, to a domain-specific chatbot, such as one offered by a retailer, financial institution, technology service provider, or others. The domain-specific chatbot may be associated with any business, organization, or entity, where such chats can include and/or leverage domain-specific knowledge, language, and/or learning specific to the entity, such that specific offerings, products, services, and operations related to that entity can be performed via the domain-specific chatbot. Users can interact with the chatbots through a single device or computer, such as a through smartphone, tablet, or desktop/laptop. In some instances, users can interact with the chatbots via a web browser.

As shown in FIG. 1, the example environment 100 includes one or more client devices 102, a conversational search engine system 120, and a financial institution system 160, where these components are connected by a network 150. The function and operation of each of these components is described below. While the financial institution system 160 is used for illustrative purposes and in the following examples, any suitable entity system associated with its own domain-specific chatbot may be used. For example, if searching for help with a consumer product, such as smartphone, the financial institution system 160 may be replaced by a technical support system associated with the smartphone provider or another third-party solution entity. Here, the financial institution system 160 is used to provide an example where a user is searching, via the conversational search engine system 120, to identify information related to a financial or banking need. Other similar systems may also be associated with environment 100, but are not illustrated here.

As described above, the example environment 100 enables the illustrated components to share and communicate information across devices and systems (e.g., the conversational search engine system 120, the financial institution system 160, and the client device(s) 102, among others) via network 150. As described herein, these systems can be can be cloud-based components or systems (e.g., partially or fully), while in other instances, non-cloud-based systems can be used. In some instances, non-cloud-based systems, such as on-premises systems, client-server applications, and applications running on one or more client devices, as well as combinations thereof, can use or adapt the processes described herein. Although components are shown individually, in some implementations, functionality of two or more components, systems, or servers can be provided by a single component, system, or server. Conversely, functionality that is shown or described as being performed by one component, can be performed and/or provided by two or more components, systems, or servers.

As used in the present disclosure, the term “computer” is intended to encompass any suitable processing device. For example, the conversational search engine system 120, the client device(s) 102, and/or the financial institution system 160 can be any computer or processing devices such as, for example, a blade server, general-purpose personal computer (PC), Mac®, workstation, UNIX-based workstation, or any other suitable device. Moreover, although FIG. 1 illustrates a single conversational search engine system 120, the conversational search engine system 120 can be implemented using a single system or more than those illustrated, as well as computers other than servers, including a server pool. Similarly, the financial institution system 160 can be implemented as one or more components and/or computers. In other words, the present disclosure contemplates computers other than general-purpose computers, as well as computers without conventional operating systems.

Similarly, each client device 102 can be any system that can request data and/or interact with the conversational search engine system 120, the financial institution system 160, and/or other client devices 102, among others. The client device 102, also referred to as client 102, in some instances, can be a desktop system, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The client device 102 can include a browser or other application 110 capable of connecting to and interacting with the conversational search engine system 120. The browser 110 can be a web browser or mobile web browser, or may be browser embedded or included in another application. In some instances, the browser 110 can include or execute one or more web browsers or web applications that can interact with particular applications executing remotely from the client device 102, such as the conversational search engine system 120, one or more applications executing on, associated with, or connected to the financial institution system 160, and/or one or more web pages or other relevant applications, among others.

As illustrated, one or more client devices 102 can be present in the example environment 100. Although FIG. 1 illustrates a single client device 102, multiple clients can be deployed and in use according to the particular needs, desires, or particular implementations of the environment 100. Each client device 102 can be associated with a particular user (e.g., a user who interacts with a particular chatbot provided by the conversational search engine system 120), or can be associated with/accessed by multiple users, where a particular user is associated with a current session or interaction at the client device 102. Client device 102 can be a client device at which the user is linked or associated. As illustrated, the client device 102 can include an interface 104 for communication, at least one processor 106, a graphical user interface (GUI) 108, the browser or client application 110, and a memory 112 storing information associated with the client device 102.

The illustrated client device 102 is intended to encompass any computing device, such as a desktop computer, laptop/notebook computer, mobile device, smartphone, personal data assistant (PDA), tablet computing device, one or more processors within these devices, or any other suitable processing device. In general, the client device 102 and its components can be adapted to execute any operating system. In some instances, the client device 102 can be a computer that includes an input device, such as a keypad, touch screen, or other device(s) that can interact with one or more client applications, such as one or more mobile applications, including for example a web browser, a banking application, or other suitable applications, and an output device that conveys information associated with the operation of the applications and their application windows to the user of the client device 102. Such information can include digital data, visual information, or a GUI 108, as shown with respect to the client device 102. Specifically, the client device 102 can be any computing device operable to communicate with the conversational search engine system 120, the financial institution system 160, other client devices 102, and/or other components via network 150, as well as with the network 150 itself, using a wireline or wireless connection. In general, the client device 102 comprises an electronic computer device operable to receive, transmit, process, and store any appropriate data associated with the environment 100 of FIG. 1.

The browser or client application 110, as noted above, executing on the client device 102, can include any suitable application, program, mobile app, or other component. The browser 110 can interact with the conversational search engine system 120, the financial institution system 160, and/or other client devices 102, or portions thereof, via network 150. In some instances, the browser 110 can be a web browser, where the functionality of the browser 110 can be realized using a web application or website that the user can access and interact with via the browser 110. In other instances, the browser 110 can be a remote agent, component, or client-side version of the contextual search engine 126, the financial institution system 160, or of any other application or system. In some instances, the browser 110 can interact directly or indirectly (e.g., via a proxy server or device) with the conversational search engine 126, the financial institution system 160, or portions thereof. The browser 110 can be used to view, interact with, or otherwise transact data exchanges and activities with the conversational search engine 126 or the financial institution system 160, as well as other systems, and to allow interactions associated with the subject matter described herein.

GUI 108 of the client device 102 interfaces with at least a portion of the environment 100 for any suitable purpose, including generating a visual representation of any particular browser or application 110 and/or the content associated with any components of the contextual search engine 126, the financial institution system 160, other systems, and/or other client devices 102. For example, the GUI 108 can be used to present screens and information associated with the contextual search engine 126 (e.g., chat interfaces presenting prompts and responses) and interactions associated therewith, as well as presentations associated with the financial institution system 160 (e.g., one or more interfaces for identifying financial information and interactions, as well as chat interfaces associated with the domain-specific conversational AI 168), among other possibilities. GUI 108 can also be used to view and interact with various web pages, applications, and web services located local or external to the client device 102. Generally, the GUI 108 provides the user with an efficient and user-friendly presentation of data provided by or communicated within the system. The GUI 108 can comprise a plurality of customizable frames or views having interactive fields, pull-down lists, and buttons operated by the user. In general, the GUI 108 is often configurable, supports a combination of tables and graphs (bar, line, pie, status dials, etc.), and is able to build real-time portals, application windows, and presentations. Therefore, the GUI 108 contemplates any suitable graphical user interface, such as a combination of a generic web browser, a web-enable application, intelligent engine, and command line interface (CLI) that processes information in the platform and efficiently presents the results to the user visually.

The interface 104 of the client device 102 is used by the client device 102 for communicating with other systems in a distributed environment—including within the environment 100—connected to the network 150, e.g., the conversational search engine system 120, the financial institution system 160, other client device(s) 102, and other systems communicably coupled to the client device 102 and/or network 150. Generally, the interface 104 comprises logic encoded in software and/or hardware in a suitable combination and operable to communicate with the network 150 and other components. More specifically, the interface 104 can comprise software supporting one or more communication protocols associated with communications such that the network 150 and/or interface's hardware is operable to communicate physical signals within and outside of the illustrated environment 100. Still further, the interface 104 can allow the client device 102 to communicate with the connected or communicably coupled components illustrated in FIG. 1, as well as other systems not illustrated herein.

Memory 112 of the client device 102 can represent a single memory or multiple memories. The memory 112 can include any memory or database module and can take the form of volatile or non-volatile memory including, without limitation, magnetic media, optical media, random access memory (RAM), read-only memory (ROM), removable media, or any other suitable local or remote memory component. The memory 112 can store various objects or data associated with the client device 102. While illustrated within the client device 102, memory 112 or any portion thereof, can be located remote from the client device 102 in some instances, including as a cloud application or repository, or as a separate cloud application or repository. Memory 112 can store any client-specific data, information, or applications for use on the client device 102. Other suitable information can also be stored or referenced within memory 112.

The conversational search engine system 120 may be associated with, or can be, a generic chatbot (i.e., the conversational search engine 126) used to perform general and/or specific searches, where users can submit one or more prompts or queries in natural language, and where the conversational search engine 126 takes those queries or prompts and generates responsive answers, also in a natural language format. Examples of existing conversational search engines can include, as noted above, Google's Bard or Microsoft's Bing Chat, among others. In some instances, the conversational search engine system 120 may be a cloud-based system, and can be associated with a large language model (LLM) 142 that allows the conversational search engine 126 to interpret and respond to the queries. The LLM 142 may be a relatively generic language model, and may not be specific to any particular purpose other than a general search. In some instances, the search engine 126 and its LLM 142 may be supplemented and trained to provide new and additional learning, and can answer specific questions or queries associated with a large assortment of topics.

As illustrated, the conversational search engine system 120 includes or is associated with interface 122, processor(s) 124, the conversational search engine 126, and memory 140. While illustrated as provided by or included in the conversational search engine system 120, parts of the illustrated components/functionality of the conversational search engine system 120 can be separate or remote from the conversational search engine system 120, or the conversational search engine system 120 can itself be distributed across the network 150.

The interface 122 of the conversational search engine system 120 may be similar to or different from interface 104 of the client device 102, and is used by the conversational search engine system 120 for communicating with other systems in a distributed environment—including within the environment 100—connected to the network 150, e.g., the financial institution system 160, the client device(s) 102, and other systems communicably coupled to the illustrated conversational search engine system 120 and/or network 150. Generally, the interface 122 comprises logic encoded in software and/or hardware in a suitable combination and operable to communicate with the network 150 and other components. More specifically, the interface 122 can comprise software supporting one or more communication protocols associated with communications such that the network 150 and/or interface's hardware is operable to communicate physical signals within and outside of the illustrated environment 100. Still further, the interface 122 can allow the conversational search engine system 120 to communicate with the connected or communicably coupled components illustrated in FIG. 1, as well as other systems not illustrated herein.

The conversational search engine system 120, as illustrated, includes one or more processors 124. Although illustrated as a single processor 124 in FIG. 1, multiple processors can be used according to particular needs, desires, or particular implementations of the environment 100. Each processor 124 can be a central processing unit (CPU), an application specific integrated circuit (ASIC), a field-programmable gate array (FPGA), or another suitable component. Generally, the processor 124 executes instructions and manipulates data to perform the operations of the conversational search engine system 120. Specifically, the processor 124 executes the algorithms and operations described in the illustrated figures, as well as the various software modules and functionality, including the functionality for sending communications to and receiving transmissions from the client device(s) 102 and the financial institution system 160, as well as to other devices and systems. Each processor 124 can have a single or multiple cores, with each core available to host and execute an individual processing thread. Further, the number of, types of, and particular processors 124 used to execute the operations described herein can be dynamically determined based on a number of requests, interactions, and operations associated with the conversational search engine system 120.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including, e.g., C, C++, JavaScript, Java™, Visual Basic, assembler, Perl®, any suitable version of 4GL, as well as others.

As illustrated, the conversational search engine 126 can be one or more applications, entities, programs, agents, or other software or similar components configured to perform and/or provide the generic chatbot functionality described herein. As illustrated, the conversational search engine 126 can be associated with one or more domain-specific configuration profiles 128. While illustrated within the conversation search engine 126 in FIG. 1, these profiles 128 may be stored or referenced in memory 140, in some instances.

The domain-specific configuration profiles 128 can be provided by the entities to assist with search engine optimization, but can be stored or referenced in or for the generic chatbot. Specifically, the profiles 128 may be used to connect specific terms, recommendations, and/or other search results to operations or interactions with a particular entity. Additionally, the profiles 128 can define and/or identify one or more endpoints associated with the entity to which users should be directed, should the conversation at the generic chatbot be relevant to the terms, recommendations, and/or other search results associated with the particular entity. When a match or relationship to the related terms or recommendations are returned, the conversational search engine 126 can suggest the endpoint or result. In some instances, the conversational search engine 126 can insert an interactive UI element linked to, or that sends the user to, the identified endpoint to trigger a transfer of the conversation from the conversational search engine 126 to the domain-specific chatbot 168.

The profiles 128 can also include one or more disclaimers (e.g., FI disclaimer 132, and disclaimer(s) 136) prepared or provided by the corresponding entity. In addition to disclaimers, legal terms and conditions can be provided (e.g., if associated with investing advice, possible account opening, etc.), as well as privacy statements, notices, and other information the entity wants, or needs, to have presented when transferring the context of the chat interactions from the generic chatbot to the domain-specific chatbot. In some instances, links to some of those sets of information may be provided, and can be inserted into a template transfer UI presented by the generic chatbot, where at least some of the information in the profiles 128 is inserted directly into the transfer UI, including as hyperlinks to relevant pages or resources stored remote from the conversational search engine system 120. In some instances, the profiles 128 may also include settings, such as timeout settings and other parameters, associated with transfers to the entity. Similarly, failover links and endpoints may be provided to allow for additional options should the primary endpoints be unavailable.

Several example profiles 128 are illustrated in FIG. 1. For example, the financial institution system 160 and its associated entity may have already registered a profile 130 with the conversational search engine system 120. The profile 130 can identify particular endpoints of the financial institution to be used when particular terms or recommendations associated with the financial institution are returned or determined by the conversational search engine 126. Those endpoints may be associated with particular APIs or interfaces managed by or associated with the financial institution system 160, which can be used to direct the user to the corresponding domain-specific chatbot 168 of the financial institution system 160. As noted, an FI-related disclaimer 132 may be included, as well as any other required or desired privacy statements, terms and conditions, or other relevant information.

As illustrated, other profiles 134 for other entities may be registered at the conversational search engine system 120 as well, such that search responses, recommendations, and links associated with those other entities can allow the conversational search engine 126 to transfer the generic chatbot to the domain-specific chatbots associated with those entities. In those instances, the generic chatbot can be greatly enhanced and lead to deeper chatbot experiences with a plurality of entities. Any number of other profiles 134 can be registered, each with their own respective disclaimers 136 and related profile information, and can be associated with any number of entities. Still further, some of the other profiles 134 may also be associated with the financial institution system 160, but for different functionality and/or interactions or operations. For instance, one profile 128 of the financial institution may be associated with a car loan-related chatbot and operations, while another profile 134 may be associated with a mortgage-related chatbot and associated operations. Those profiles may be associated with different endpoints, both associated with the financial institution. In some other instances, those profiles may be associated with the same endpoint, where the passed or transferred context can be used at the domain-specific chatbot to understand the purpose of the chat, where the domain-specific chatbot 168 can then provide what the user needs for both or either aspect after the transfer is completed, and when the chat and its earlier context is obtained by or analyzed at the financial system's chatbot 168.

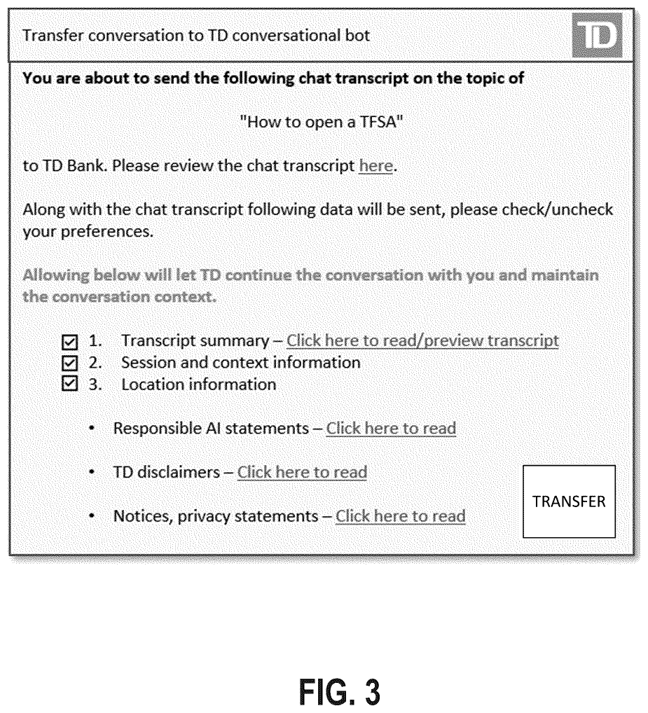

As illustrated, the conversational search engine 126 includes a context transfer engine 138, which manages the transfer operations from the conversational search engine 126 to the corresponding domain-specific chatbot (e.g., domain-specific chatbot 168). The context transfer engine 138 can, when an entity-related search term is identified that is associated with a particular profile 128, access the relevant information from the particular profile 128, and generate a transfer UI or other presentation to be provided when a transfer is suggested or available. An example transfer UI is illustrated in FIG. 3, and is described below.

Once a potential endpoint is identified from the corresponding profile in response to an ongoing conversation, the context transfer engine 138 can insert, into the contextual interface, an interactive UI element for connecting and transferring the chat to the domain-specific chatbot 168. If the user is determined to interact with the interactive UI element, or otherwise has indicated that a transfer is to take place (e.g., via a prompt in response to the UI element, or other suitable indication, such as when no interactive UI element is provided, but instead a response asking if the user would like to be transferred to a domain-specific chatbot), then the context transfer engine 138 collects the relevant information associated with the user and the current session from its systems.

As illustrated, a session context 144 may be available for a current chat interaction. Multiple session contexts 144 may be available for concurrent users, in some cases. For a particular session, the context 144 can include a transcript 146 of the current chat, which can include prompts from the user and responses from the conversational search engine 126. Additionally, the context 144 can include relevant user data 147, which may include information identifying the user (i.e., user identifying info 148), as well as information associated with the user's location 149. Other contextual information that could be available for inclusion in the transfer may include browser settings, session details, additional location information, a generated summary of the conversation (which may be generated at the time of the transfer if not available before), a full chat transcript, a search query that triggered the chat, the particular query that resulted in the profile being identified or triggered, and/or any other suitable information.

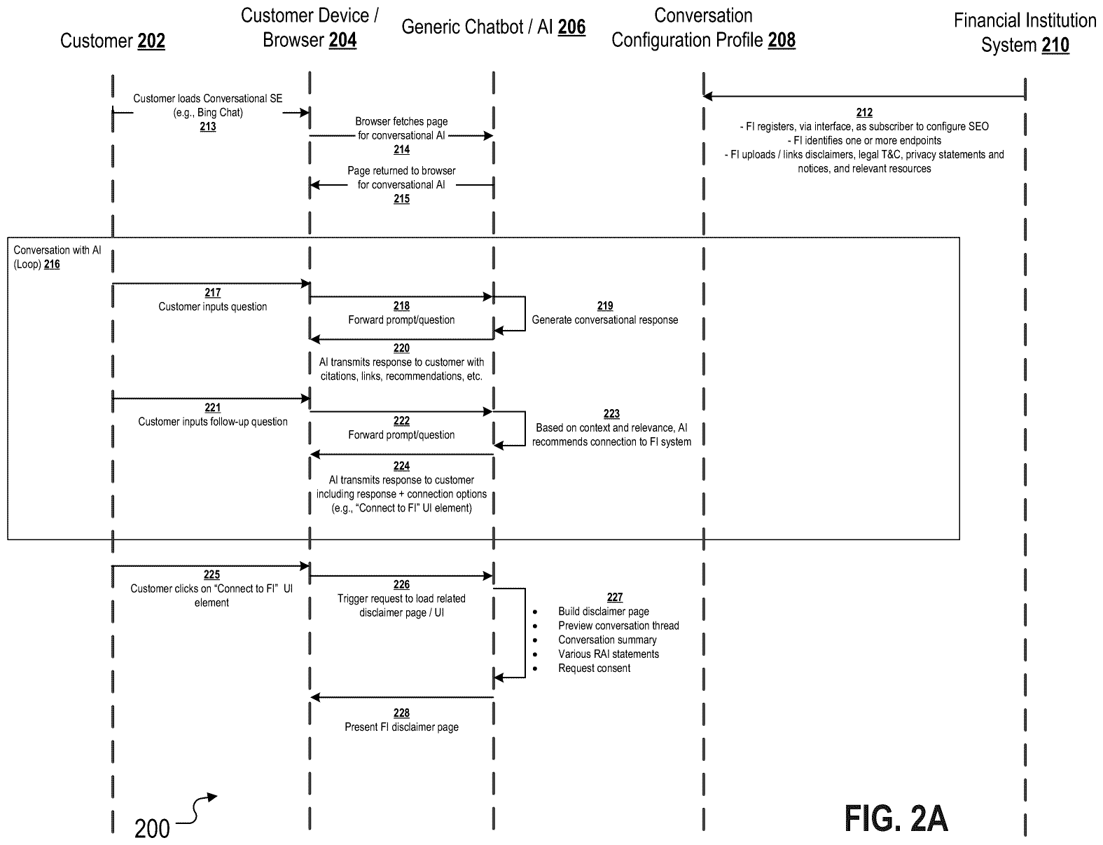

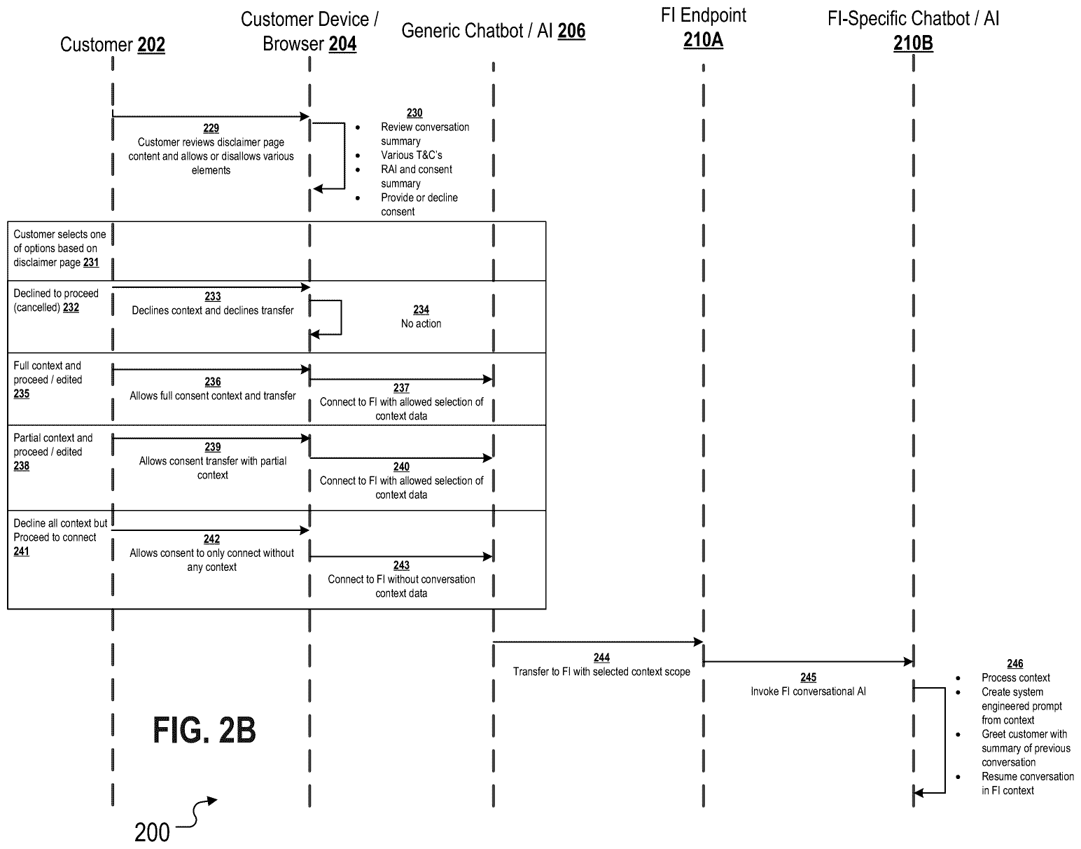

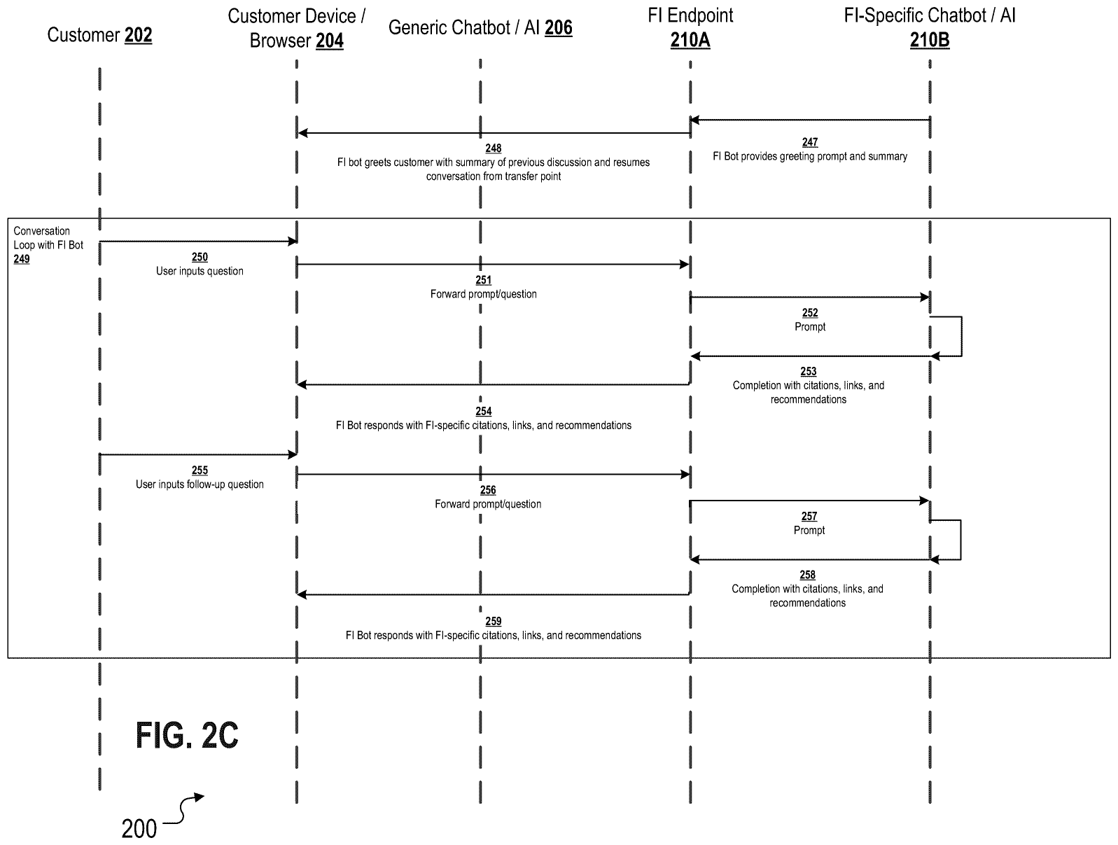

Once that information is collected or obtained, the transfer UI can be populated with at least some of the collected information and presented to the user via a user interface. As described in FIG. 2, users can review the information collected during the session with the contextual search engine 126, and choose which information should be transferred to the domain-specific chatbot. In some instances, a full or partial transcript can be available for review. Users can be given the option to include the full or partial transcript, a transcript summary, session information (which may include or be separate from particular context information), and location information, among others. Additionally, any identified disclaimers, legal data, notices, and privacy statements can be viewed. The user can select the type and amount of information to be shared—either all, some specifically identified information, or none of the information—and can initiate the transfer.

The context transfer engine 138 can send, pass, or otherwise transfer the conversation and context to the endpoint based on the conversational search engine system's 120 capabilities. In some instances, an HTTPS GET request can be used, where a unique identifier is sent to the appropriate endpoint as a webhook. The backend system associated with the endpoint can then use that unique identifier to pull the shared details of the conversation from the conversational search engine system 120. In other instances, an HTTPS POST request can be used, where the details of the transfer can be encrypted in the payload and can be provided to the endpoint associated with the transfer. Still further, a variation of an OAuth 2.0-style flow, such as an authorization code flow, can be used to allow users to set scopes of what is shared. Any suitable manner of sharing and transferring the information can be used.

Memory 140, associated with conversational search engine system 120, can represent a single memory or multiple memories. The memory 140 can include any memory or database module and can take the form of volatile or non-volatile memory including, without limitation, magnetic media, optical media, random access memory (RAM), read-only memory (ROM), removable media, or any other suitable local or remote memory component. The memory 140 can store various objects or data associated with the conversational search engine 126, including any parameters, variables, algorithms, instructions, rules, constraints, or references thereto. While illustrated within the conversational search engine system 120, memory 140 or any portion thereof, including some or all of the particular illustrated components, can be located remote from the conversational search engine system 120 in some instances, including as a cloud application or repository, or as a separate cloud application or repository when the conversational search engine system 120 itself is a cloud-based system. As demonstrated, memory 140 stores the LLM 142 associated with the conversational search engine system 120, as well as session contexts 144. Other suitable information can also be stored or referenced within memory 140.

Network 150 facilitates wireless or wireline communications between the components of the environment 100 (e.g., between the conversational search engine system 120, the financial institution system 160, and the client device(s) 102, etc.), as well as with any other local or remote computers, such as additional mobile devices, clients, servers, or other devices communicably coupled to network 150, including those not illustrated in FIG. 1. In the illustrated environment, the network 150 is depicted as a single network, but can be comprised of more than one network without departing from the scope of this disclosure, so long as at least a portion of the network 150 can facilitate communications between senders and recipients. In some instances, one or more of the illustrated components (e.g., between the conversational search engine system 120, the financial institution system 160, and the client device(s) 102, etc.) can be included within or deployed to network 150 or a portion thereof as one or more cloud-based services or operations. The network 150 can be all or a portion of an enterprise or secured network, while in another instance, at least a portion of the network 150 can represent a connection to the Internet. In some instances, a portion of the network 150 can be a virtual private network (VPN). Further, all or a portion of the network 150 can comprise either a wireline or wireless link. Example wireless links can include 802.11a/b/g/n/ac, 802.20, 5G, LTE, and/or any other appropriate wireless link. In other words, the network 150 encompasses any internal or external network, networks, sub-network, or combination thereof operable to facilitate communications between various computing components inside and outside the illustrated environment 100. The network 150 can communicate, for example, Internet Protocol (IP) packets, Frame Relay frames, Asynchronous Transfer Mode (ATM) cells, voice, video, data, and other suitable information between network addresses. The network 150 can also include one or more local area networks (LANs), radio access networks (RANs), metropolitan area networks (MANs), wide area networks (WANs), all or a portion of the Internet, and/or any other communication system or systems at one or more locations.

Financial institution system 160 is illustrated as one possible implementation of the present solution, and is associated with at least one domain-specific configuration profile 128 stored at or referenced by the conversational search engine 126 (i.e., FI conversational search engine configuration profile 130). In general, the financial institution system 160 is meant to represent an example system with which can be connected to the client device 102 and its user in response to the conversational search engine 126 identifying particular recommendations and links responsive to the user's conversational search. As described, those connected links and recommendations, as identified by the profiles 128, can be used to allow the handoff from the conversational search engine 126 to the domain-specific conversational AI 168, via a defined handoff interface 166. The handoff interface 166 can be a defined endpoint as included in the profile 130, and can be accessed initially to move the user to the domain-specific conversational AI 168. FIGS. 2A-C describe the process in further detail. In some instances, the handoff interface 166 can be an application programming interface (API) specific to the financial institution system 160, and that can be used to forward the interaction to the specific domain-specific conversational AI 168 associated with the corresponding profile 128. In some instances, a single handoff interface 166 can be used even where multiple domain-specific conversational AIs 168 are available for a single entity (e.g., the financial institution). Similarly, multiple handoff interfaces 166 can be used for a single entity having a single domain-specific conversational AI 168, where the different handoff interfaces 166 provide a use-specific entry point to the AI 168 and its chatbot. While illustrated as internal to the financial institution system 160, the handoff interface 166 may be located in any suitable system, and can receive and process transfer requests while connecting the browser 110 to the domain-specific chatbot 168.

As illustrated, the financial institution system 160 includes interface 162, at least one processor 164, the handoff interface 166, the domain-specific conversational AI 168, a financial institution backend system (FI backend system 170), and memory 174. Interface 162 may be similar to or different from interfaces 104 or 122 (and can allow the financial institution system 160 to communicate with other systems, components, including via network 150), and the at least one processor 164 may be similar to or different from processors 106 and 124 (and can execute the operations of the financial institution system 160 and its components).

The FI backend system 170 can represent any backend systems of the financial institution system 160, as well as other operations, that can be accessed, at least in part, by the domain-specific conversational AI 168. For example, if the domain-specific conversational AI 168 is built to assist with opening an account at the financial institution, then the FI backend system 170 may be associated, at least in part, with banking systems capable of opening new accounts. The domain-specific conversational AI 168 can use its knowledge and connection to the backend system 170, as well as the relevant user information 176, to perform the operations via the domain-specific chatbot 168, or to provide support for doing so locally within the domain of the financial system 160. In some instances, particularly where the financial institution system 160 (or any other 3^{rd} party system separate from the conversational search engine system 120), multiple backend systems 170 may be available. The domain-specific conversational AI 168, using its training, understanding of the backend system(s) 170, and its domain-specific LLM 184 and/or other training and domain-specific information, can obtain the information from the generic chatbot of the conversational search engine 126, and can use that information to manage one or more operations and interactions on the backend.

As illustrated, memory 174 can store various information. In general, memory 174 may be similar to or different from memories 112 and/or 140. As illustrated, memory 174 can store information specific about one or more users as user information 176. Additionally, memory 174 can store a domain-specific LLM 184 to support the intelligence and understanding of the domain-specific conversational AI 168. Similarly, any suitable information can be stored in or referenced by memory 174 to support the one or more backend systems 170. Specific to the present solution, memory 174 can store a combined transcript 178, which can be used to collect and combine the transcripts and contexts as identified during the domain-specific chat interactions, as well as those received from the conversational search engine 120 during the handoff process. The combined transcript 178 can the contents or components of the transferred transcript and context 180 from the session context 144 that is allowed or authorized to be shared during the transfer process. Further, the combined transcript 178 can then include any relevant interactions, transcripts, or context from interactions with the domain-specific conversational AI 168 after the transfer, which can be stored or collected at a domain chat transcript 182. The domain chat transcript 182 can similarly include context information to the conversation, as well as identify additional information about the user. In some instances, the domain chat transcript 182, and therefore the combined transcript 178, can be associated directly with an existing user's information from the user information 176, allowing the domain-specific conversational AI 168 to connect any existing accounts or potential offers/actions associated with the user to the ongoing interaction. If the user has not previously been associated with the financial institution system 160, the domain-specific conversation AI 168, in combination with one of the FI backend systems 170, can create a new account or user identifier and store that information in the user info 176 for later use, and connection with the combined transcript 178 and domain chat transcript 182. As noted above, and in FIG. 2A-C, the transferred transcript and context 180 may only be a partial transcript and user or session context in some cases, depending on the level of sharing and transfer selected by the user.

While portions of the elements illustrated in FIG. 1 are shown as individual components that implement the various features and functionality through various objects, methods, or other processes, the software may instead include a number of sub-components, third-party services, libraries, and such, as appropriate. Conversely, the features and functionality of various components can be combined into single components as appropriate.

FIGS. 2A-C illustrate an example swim lane diagram 200 between a browser, a generic chatbot, and a domain-specific chatbot to allow for transferring context from the generic chatbot to the domain-specific chatbot. FIG. 2A illustrates an example swim lane diagram 200 between a customer 202, a customer device or browser 204, a generic chatbot or conversational AI 206, a set of information defining a conversation configuration profile 208, and a financial institution system 210. The financial institution system 210 in FIG. 2A is then shown, for convenience, as financial institution (FI) endpoint 210A and FI-specific conversational AI or chatbot 210B in FIGS. 2B and 2C. As noted in FIG. 1, the financial institution system 210 can be any type of system separate from the generic chatbot 206, where the financial institution could be any suitable separate system associated with a domain-specific chatbot.

At 212, the financial institution system 210 can register, via any suitable interface or mechanism of the generic chatbot, as a subscriber or registered entity of the generic chatbot, and can provide that registration as a conversation configuration profile 208. The conversation configuration profile 208 can be used to register one or more endpoints of a particular entity with the generic conversational chatbot 206, such that when relevant terms or recommendations are generated, one or more endpoints can be included or identified in the search results that may lead the conversation from a generic chatbot to a domain-specific chatbot. The information provided in the profile 208 can be used by the generic chatbot 206 to provide links or references to one or more endpoints (e.g., FI endpoint 210A) that provide an entry or connection to the domain-specific chatbot.

In some instances, a search engine optimization interface or website can be used for the registration process. In some instances, the financial institution system 210 can register, identify, or submit one or more endpoints that can be connected to, associated with, or triggered by conversational search results of the generic chatbot, and that provide links to the domain-specific chatbot 210B of the financial institution. When the results of an ongoing search are associated with particular registered or linked terms or recommendations (e.g., “cryptocurrency”, “open a banking account,” “investing my savings,” “apply for a mortgage,” etc.), the generic chatbot 206 can identify and provide the endpoints (e.g., FI endpoint 210A) corresponding to or related to those terms or recommendations to the current user, either as or along with the results or suggestions. Those endpoints may be available as links to use in association with a particular result or suggestion, and can be associated with a selectable UI element. The provided endpoints and selectable/interactive UI element can allow users to choose to transfer the context of their ongoing interaction with the generic chatbot 206 to the corresponding domain-specific chatbot (e.g., chatbot 210B), where, during the transfer, the solution allows users to share at least a portion of the generic chatbot interaction context to the domain-specific chatbot. In doing so, additional initial context is provided between the chatbots during the handoff, and allows the domain-specific chatbot to take advantage of the previous interactions.

In addition to identifying those endpoints, the financial institution system 210 can also upload or link particular disclaimers, terms and conditions, privacy statements, notices, and relevant resources that may be presented and/or provided to users prior to a transfer from the generic chatbot 206 to the domain-specific chatbot (i.e., FI chatbot 210B).

Any number of systems may register with the generic chatbot 206 to provide one or more endpoints and connected terms or recommendations. In some instances, multiple endpoints may be associated with the same entity, and in some instances, with the same domain-specific chatbot. In other instances, a single endpoint may be used for a single entity and chatbot, such that any conversation triggering the domain-specific chatbot can be associated with a single endpoint. By transferring the context of the generic chatbot, however, the domain-specific chatbot can immediately identify the current context and intention of the interaction, as well as information about the user associated with the interaction.

At 213, the customer 202 can begin their interaction by attempting to load the generic chatbot 206 on their customer device or browser 204. In some instances, the generic chatbot 206 may be Bing Chat by Microsoft, or Bard by Google, among others. At 214, the browser 204 can request or fetch pages for the generic chatbot 206, and at 215, a page is returned to the browser 204 corresponding to the request and the generic chatbot 206.

A conversation 216 can begin between the customer 202 and the generic chatbot 206 as illustrated in the box. At 217, the customer 202 can input a question or prompt into their browser 204, and the browser 204 can forward that prompt or question at 218 to the generic chatbot 206. The generic chatbot 206 can process the received request and generate a conversational response at 219, and can transmit back (at 220) a response to the customer with a natural language response, which may include text, a citation, a link, or a recommendation, among others.

After reviewing the response, the customer 202 can input a follow-up question at 221, and the browser 204 can forward (at 222) that prompt or question to the generic chatbot at 206. Any number of rounds of the conversation can take place, as the generic chatbot 206 provides a conversation-based interaction. With the request of 222, however, the results of the generic chatbot 206 identify at least one recommended connection or link to an endpoint associated with the financial institution. At 223, based on the context and relevance of the request or prompt to the terms and recommendations associated with a particular profile 208, the generic chatbot 206 can recommend a connection to a particular endpoint. In doing so, a response to the received request or prompt (222) is generated, and a UI element or other indication of a recommended connection to the financial system 210 can be provided in the response at 224, along with the response. In some instances, the UI element may include a button or other clear indication of action, such as a button with the text “Connect to FI”, or a similar indication of the option. The UI element or button could be embedded in the response presented to the customer, or the generic chatbot may ask for a chat-based confirmation, such as a yes or no request, if the customer would like to connect to the FI system.

After 224, the loop 216 may be left if the customer clicks on the UI element or otherwise indicates to move to the new system at 225. If not, the loop can continue. After clicking on the UI element, the browser 204 can then trigger a request to load a related disclaimer page or UI associated with the selected transfer at 226. At 227, the generic chatbot 206 can build a disclaimer page and transfer UI that can be presented to the customer 202 prior to the transfer occurring. The disclaimer page and transfer UI can be based both on the current session with the generic chatbot 206, as well as information included in the configuration profile 208 of the FI system. For example, from the current session, a conversation thread and contents may be available, as well as a conversation summary. From the profile 208, various information, including those associated with disclaimers for use of the domain-specific chatbot and any financial disclosure, can be obtained and included in the disclaimer page and UI. The transfer UI can also provide the customer options as to what and how much to share from the generic chatbot discussion to the domain-specific chatbot. Various levels of sharing may be an option for the customer. At 228, the disclaimer and transfer UI page can be provided to the browser 204 and presented to the customer.

FIG. 3 illustrates an example transfer UI, where the proposed financial system is associated with TD Bank. As illustrated, the transfer UI can clearly denote that a transfer from the generic chatbot to a TD-owned conversational bot is being performed. In this instance, the discussion with the general chatbot related to opening a tax-free saving account, or TFSA. In response to those searches, the general chatbot determined that such a term (i.e., TFSA) had been registered with TD-related endpoints and the TD-based chatbot. In response, the generic chatbot suggested a move to the TD system, and at this point, the customer has elected to start the transfer. As illustrated, the transfer UI indicates that TD's chatbot will be continuing the discussion, and provides information related to what the customer would like to share from the initial chat. Here, the customer is provided the option to share the transcript, and is given the ability to read/preview the full transcript. The customer is also asked whether to share session and context information, as well as location information, to the TD system. Further, disclaimers and notices are included and available for review before moving forward. The disclaimers can include statements about responsible AI use, disclaimers specific to TD, and any notices and privacy statements, as well as those required by law. Once selections are made, the “Transfer” button can be selected, and the transfer can be started.

Returning to FIG. 2B, at 229 the customer can review the disclaimer page content and make selections to allow or disallow particular elements and information. At 230, the browser 204 can allow the customer to review the conversation summary, review various terms and conditions, allow the user to select or consent to sharing information, and can provide or decline consent for the transfer. At 231, the customer can select one of several options.

In a first option (232), the customer may decline to proceed. In that instance, the customer 202 can indicate that they do not want the transfer to occur at 233, and no action is taken (234). No transfer will be performed.

In a second option (235), the customer can elect to provide full consent for all information and content to be transferred at 236. The browser 204, based on that indication, can then indicate to the generic chatbot at 237 to connect to the financial system and provide the allowed selection and context data.

In a third option (238), the customer can elect to only share a partial context (at 239), but to still proceed with the transfer. The browser 204, based on that indication, can then indicate to the generic chatbot at 240 to connect to the financial system and initiate the transfer the allowed selection and context data.

In a fourth option (241), the customer can elect to only transfer to the financial system, but without any context, at 242. The browser 204, based on that indication, can then indicate to the generic chatbot at 243 to connect to the financial system and transfer the conversation, but without any additional context information.

Context information, for example, can include any types of relevant information related to the customer and/or the prior interaction. Examples of context information include, but are not limited to, browser settings, session details, customer location information, a summary of the conversation, a full chat transcript of the initial interactions, a search query or prompt that triggered or otherwise started the chat, a search query or prompt that caused the connection to the second system, and any other detail that may be available, including customer-specific and/or customer-identifying information.

At 244, the generic chatbot 206 can connect to the FI endpoint 210A, which may be an API, a web interface, or web application, among others. In connecting to the FI endpoint 210A, the generic chatbot 206 can provide or make available the information associated with the transferred session. In some instances, information can be embedded in the communication of the transfer (244), while in others, information can be made available via a reference to where the information is available, and the reference can be provided to the FI endpoint 210A. The options or methods on how to provide the information to the domain-specific endpoint can be based on how and what the generic chatbot is capable of doing. In one instance, an HTTPS GET request can be used, where a unique ID is sent to the endpoint as a webhook. The backend system of the financial system can then connect to a backchannel or entry point of the generic chatbot to access the allowed details of the initial conversation. Alternatively, an HTTPS POST request can be used, where all of the allowed details can be encrypted in the payload of the request. Any other suitable communication or information sharing can be used at 244.

At 245, the FI endpoint 210A can invoke the FI-specific chatbot 210B. At 246, the FI-specific chatbot 210B can then access and process the information defining the context from the initial conversation, and can create a system-engineered prompt from the received context. In some instances, the FI-specific chatbot 210B can greet the customer with a summary of the previous conversation to indicate that the information has been shared. Once the information is collected, a new conversation is started at the FI-specific chatbot 210B that represents the resumption of the initial conversation with the generic chatbot 206.

At 247, the FI-specific chatbot can provide the greeting prompt and summary back to the FI endpoint 210A, which can then be returned to the browser 204 (at 248) to allow the conversation to seamlessly resume from the transfer point.

Another conversation loop 249 can then be performed with the FI-specific chatbot 210B based on the conversation started earlier with the generic chatbot 206. At 250, the customer can input a question or prompt to the browser 204, which can then forward the prompt or question to the FI endpoint 210A (at 251). The FI endpoint 210A can then provide that prompt to the FI-specific chatbot (at 252), which can generate a responsive message with any appropriate response, which may include citations, links, recommendations, or any other suitable response at 253. The FI endpoint 210A, now connected or communicable with the browser 204, can forward the FI-specific chatbot response at 254. The customer can review the response, and input or provide a follow-up question or set of questions at 255, where the browser 204 sends those follow-ups to the FI endpoint 210A at 256, where the FI endpoint 210A relays those prompts to the FI-specific chatbot 210B at 257. Again, the FI-specific chatbot can provide a set of responses at 258 to the FI endpoint 210A, and the responses can be provided back to the browser 204 (at 259). The loop 249 can continue until the conversation is completed, and any relevant tasks or information is obtained by the customer 202.

Although not illustrated, in some cases, the handover process of 244 can include authentication of the customer 202 to determine if the customer is an existing customer or user associated with the financial system at the time of handover. In some instances, additional authentication can be used to add additional context to the user at the financial system. The additional authentication can be the identification of cookies associated with the financial system from browser 204, while in other instances, the option to log in using credentials may be provided. The added authentication can be used by the FI-specific chatbot 210B to further customize the resumed conversation.

In some instances, the interaction with the generic chatbot 206 may occur in a first window, screen, page, or instance of the browser 204. When the connection to the FI-specific chatbot 210B is created, or when the transfer is sent to the FI endpoint 210A, the same window, screen, page, or instance of the browser 204 may host the conversation, while in other instances, a new window, screen, page, or instance of the browser 204 may be used to continue the conversation.

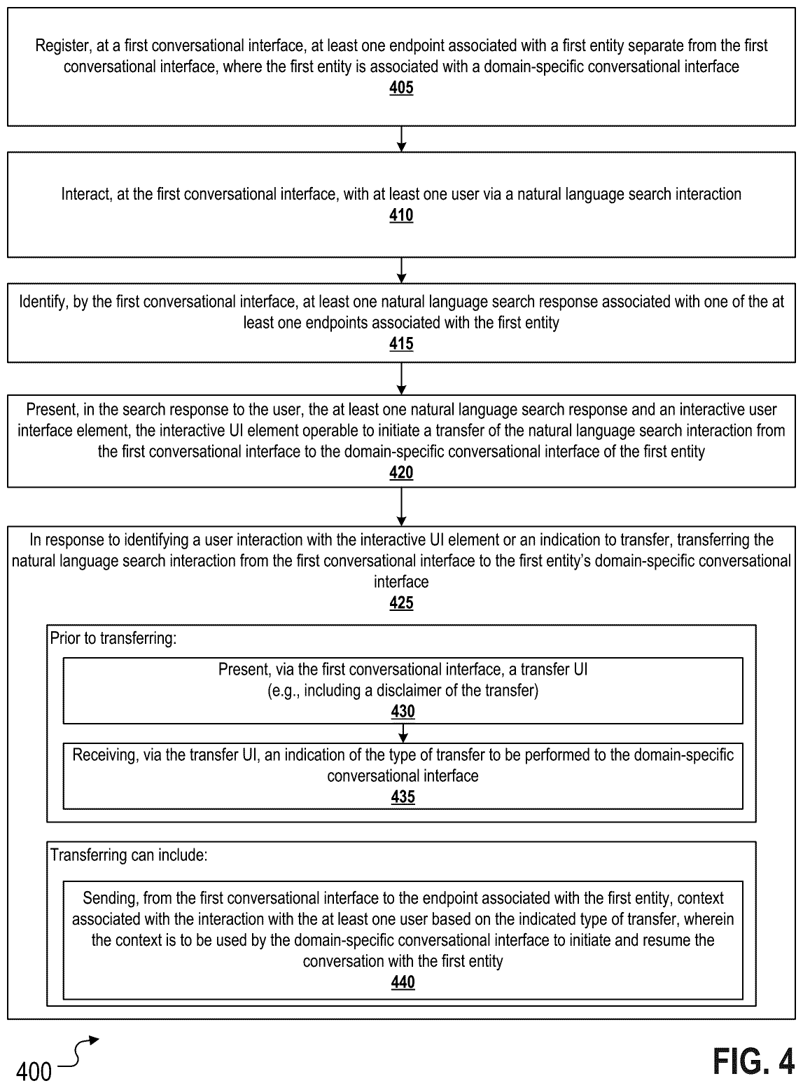

FIG. 4 is a flow diagram of an example method for transferring contexts from a generic chatbot to a domain-specific chatbot. It will be understood that process 400 and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute process 400. In some implementations, the process 400 and related methods are executed by one or more components of the environment 100 described above with respect to FIG. 1, such as the conversational search engine system 120.

At 405, at least one endpoint associated with a first entity is registered at a first conversational interface. The first entity can be separate from the first conversational interface, and the first entity can also be associated with a domain-specific conversational interface. Registering the at least one endpoint associated with the first entity can include identifying one or more terms, phrases, or concepts with the first entity. In some instances, the at least one endpoint can be an API, web application, webpage, or link associated with the first entity. When an interaction at the first conversation interface results in a response associated with one of the registered terms, the corresponding endpoints can be included in the suggestion to the user. In some instances, multiple entities can each register different endpoints associated with themselves, allowing a relatively generic conversational interface the ability to connect to two or more different domain-specific conversational interfaces in response to interactions relating to terms, topics, or subjects related to those various entities.

At 410, interactions with at least one user can be performed at the first conversational interface via a natural language search or conversation. In some instances, the first conversational interface may be Bing Chat, or another similar program, application, or tool.

At 415, during one of the conversations, the first conversational interface can identify at least one natural language search response associated with one of the at least one endpoints associated with the first entity registered with the first conversational interface, where the search response is to be provided to a first user.

At 420, in the search response to the first user, the first conversational interface can present the at least one natural language search response and an interactive suggestion or recommendation to initiate a transfer of the natural language search interaction from the first conversational interface to a domain-specific conversational interface of the first entity. In some instances, the interactive suggestion or recommendation to initiate the transfer may be associated with an interactive UI element. When the interactive UI element is interacted with, such as by an activation or click, an indication of a request to transfer the conversation from the first conversational interface to the first entity's domain-specific conversational interface can be triggered, and a transfer process can be started. In some instances, no specific UI element may be provided to the first user, but instead, a conversational natural language question or prompt can be provided to the first user, such as “Would you like to be connected to the first entity to assist with performing XYZ?”, where XYZ is the related purpose or action to be taken by the user. For instance, the operation may be the opening of a new tax-free savings account, and the connection may be to TD Bank. When the first conversational interface determines that the user is interested in opening such an account, they can generate a response that includes the recommendation to perform those actions at TD Bank with the assistance of TD Bank's domain-specific conversational interface, based at least in part on the pre-registration of such topics with the first conversational interface.

At 425, in response to identifying a user interaction or indication to initiate the transfer, the first conversational interface can transfer the natural language search interaction from the first conversational interface to the first entity's domain-specific conversational interface.

Prior to transferring, but after receiving the indication to initiate the transfer, the first conversational interface can present a transfer user interface (UI) at 430. The transfer UI can obtain information included in the registration, as well as contextual information associated with the initial conversation with the first user, to present an informed notification of the transfer action and the information to be provided to the separate system. In some instances, a copy of the full (or a partial) transcript can be linked or otherwise available for review, information on the contextual information to be shared by may be provided, and one or more disclaimers and/or terms and conditions may be available for review by the first user. Before transferring, the first user may need to interact with the transfer UI to identify which, if any, of the information is to be shared, as well as specific information as to which portions of the context is to be shared. Specifically, an indication of the type of transfer to be performed to the domain-specific conversational interface can be received at 435 via the transfer UI, and, once a selection of the type of transfer is selected, then the transfer can be initiated.

As described, the process of transferring the context from the first conversational interface to the domain-specific conversational interface can include, at 440, sending, from the first conversational interface to the endpoint associated with the first entity, a set of context information associated with the initial interaction with the at least one user, where the set of context information is to be used by the domain-specific conversational interface to initiate and resume the conversation with the first user at the first entity. In some instances, the set of context information being shared is based on a selection or indication of the type of transfer to be performed as indicated at 435.

The set of context information that can be selected can include, but is not limited to, browser settings, session details, customer location information, a summary of the conversation, a full chat transcript of the initial interactions, a search query or prompt that triggered or otherwise started the chat, a search query or prompt that caused the connection to the second system, and any other detail that may be available, including customer-specific and/or customer-identifying information.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other.

In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system comprising:
at least one memory storing instructions;
a network interface; and
at least one hardware processor interoperably coupled with the network interface and the at least one memory, wherein execution of the instructions by the at least one hardware processor causes performance of operations comprising:
receiving a registration at a first conversational interface, the registration identifying at least one endpoint associated with a first entity, wherein the first entity is separate from the first conversational interface, wherein the first entity is associated with a domain-specific conversational interface, and wherein the at least one endpoint associated with the first entity represents a connection to the domain-specific conversational interface;
interacting, via the first conversational interface, with a first user through a natural language search interaction;
identifying, by the first conversational interface, at least one response associated with one of the at least one endpoints associated with the first entity;
providing for presentation, by the first conversational interface, the at least one identified response and an interactive suggestion or recommendation to initiate a transfer of the natural language search interaction from the first conversational interface to a domain-specific conversational interface of the first entity; and
in response to identifying a user interaction from the first user indicating an intent to transfer, transferring the natural language search interaction from the first conversational interface to domain-specific conversational interface associated with the first entity.

2. The system of claim 1, wherein receiving the registration at the first conversational interface comprises:
generating a search configuration profile associated with the first entity, the search configuration profile associated with at least one search result or response and the at least one endpoint associated with the first entity; and
associating at least one of a disclosure, a set of terms and conditions, or a privacy statement with the first entity.

3. The system of claim 2, wherein transferring the natural language search interaction comprises:
obtaining, by the first conversational interface, information from the search configuration profile associated with the first entity based on the at least one identified response;
identifying a set of context associated with the natural language search interaction between the first user and first conversational interface;
generating, by the first conversational interface, a transfer UI, wherein the transfer UI is associated with the transfer of the natural language search interaction from the first conversational interface to domain-specific conversational interface associated with the first entity, and wherein the transfer UI includes at least a portion of the obtained information from the search configuration profile and at least a portion of the identified set of context associated with the natural language search interaction; and
providing for presentation, by the first conversational interface and to the first user, the transfer UI.

4. The system of claim 3, wherein the transfer UI further includes selectable UI elements associated with the at least a portion of the identified set of context, wherein the selectable UI elements are selectable by the first user to indicate which of the at least a portion of the identified set of context to provide to the domain-specific conversational interface when performing the transfer.

5. The system of claim 4, wherein the at least a portion of the identified set of context comprises at least one of browser settings associated with the browser of the first user, location information associated with the first user as determined by the first conversational interface, a full chat transcript from the interactions between the first conversational interface and the first user, or a summary of the interactions between the first conversational interface and the first user.

6. The system of claim 5, wherein the identified set of context includes the full chat transcript, and wherein the full chat transcript is included for review in the transfer UI.

7. The system of claim 4, wherein transferring the natural language search interaction from the first conversational interface to the domain-specific conversational interface associated with the first entity comprises:
identifying selections of the first user from the at least the portion of the identified set of context;
incorporating the identified selections of the first user into the transfer to the domain-specific conversational interface; and
performing the transfer from the first conversational interface to the domain-specific conversational interface associated with the first entity.

8. The system of claim 7, wherein performing the transfer from the first conversational interface to the domain-specific conversational interface associated with the first entity comprises transmitting an HTTPS POST request to the at least one endpoint associated with the first entity, wherein the HTTPS POST request includes the identified selections of the first user, and wherein the at least one endpoint associated with the first entity is operable to connect to the domain-specific conversational interface of the first entity.

9. The system of claim 7, wherein performing the transfer from the first conversational interface to the domain-specific conversational interface associated with the first entity comprises transmitting an HTTPS GET request to the at least one endpoint associated with the first entity, wherein the HTTPS GET request provides a unique identifier to the at least one endpoint, wherein the unique identifier is capable of being used by the first entity to access the identified selections of the first user from the first conversational interface via a backchannel connection, and wherein the at least one endpoint associated with the first entity is operable to connect to the domain-specific conversational interface of the first entity.

10. The system of claim 1, wherein receiving the registration at the first conversational interface comprises receiving registrations for a plurality of endpoints, the plurality of endpoints associated with the first entity and at least one other entity, wherein each of the plurality of endpoints are associated with entities separate from the first conversational interface, and wherein each of the entities is associated with at least one corresponding domain-specific conversational interface, and wherein each of the plurality of endpoints are operable to connect with a corresponding domain-specific conversational interface.

11. A non-transitory, computer-readable medium storing computer-readable instructions, that upon execution by at least one hardware processor, cause performance of operations, comprising:
receiving a registration at a first conversational interface, the registration identifying at least one endpoint associated with a first entity, wherein the first entity is separate from the first conversational interface, wherein the first entity is associated with a domain-specific conversational interface, and wherein the at least one endpoint associated with the first entity represents a connection to the domain-specific conversational interface;
interacting, via the first conversational interface, with a first user through a natural language search interaction;
identifying, by the first conversational interface, at least one response associated with one of the at least one endpoints associated with the first entity;
providing for presentation, by the first conversational interface, the at least one identified response and an interactive suggestion or recommendation to initiate a transfer of the natural language search interaction from the first conversational interface to a domain-specific conversational interface of the first entity; and
in response to identifying a user interaction from the first user indicating an intent to transfer, transferring the natural language search interaction from the first conversational interface to domain-specific conversational interface associated with the first entity.

12. The computer-readable medium of claim 11, wherein receiving the registration at the first conversational interface comprises:
generating a search configuration profile associated with the first entity, the search configuration profile associated with at least one search result or response and the at least one endpoint associated with the first entity; and
associating at least one of a disclosure, a set of terms and conditions, or a privacy statement with the first entity.

13. The computer-readable medium of claim 12, wherein transferring the natural language search interaction comprises:
obtaining, by the first conversational interface, information from the search configuration profile associated with the first entity based on the at least one identified response;
identifying a set of context associated with the natural language search interaction between the first user and first conversational interface;
generating, by the first conversational interface, a transfer UI, wherein the transfer UI is associated with the transfer of the natural language search interaction from the first conversational interface to domain-specific conversational interface associated with the first entity, and wherein the transfer UI includes at least a portion of the obtained information from the search configuration profile and at least a portion of the identified set of context associated with the natural language search interaction; and
providing for presentation, by the first conversational interface and to the first user, the transfer UI.

14. The computer-readable medium of claim 13, wherein the transfer UI further includes selectable UI elements associated with the at least a portion of the identified set of context, wherein the selectable UI elements are selectable by the first user to indicate which of the at least a portion of the identified set of context to provide to the domain-specific conversational interface when performing the transfer.

15. The computer-readable medium of claim 14, wherein the at least a portion of the identified set of context comprises at least one of browser settings associated with the browser of the first user, location information associated with the first user as determined by the first conversational interface, a full chat transcript from the interactions between the first conversational interface and the first user, or a summary of the interactions between the first conversational interface and the first user.

16. The computer-readable medium of claim 15, wherein the identified set of context includes the full chat transcript, and wherein the full chat transcript is included for review in the transfer UI.

17. The computer-readable medium of claim 14, wherein transferring the natural language search interaction from the first conversational interface to the domain-specific conversational interface associated with the first entity comprises:
identifying selections of the first user from the at least the portion of the identified set of context;
incorporating the identified selections of the first user into the transfer to the domain-specific conversational interface; and
performing the transfer from the first conversational interface to the domain-specific conversational interface associated with the first entity.

18. A computer-implemented method, comprising:
receiving a registration at a first conversational interface, the registration identifying at least one endpoint associated with a first entity, wherein the first entity is separate from the first conversational interface, wherein the first entity is associated with a domain-specific conversational interface, and wherein the at least one endpoint associated with the first entity represents a connection to the domain-specific conversational interface;
interacting, via the first conversational interface, with a first user through a natural language search interaction;
identifying, by the first conversational interface, at least one response associated with one of the at least one endpoints associated with the first entity;
providing for presentation, by the first conversational interface, the at least one identified response and an interactive suggestion or recommendation to initiate a transfer of the natural language search interaction from the first conversational interface to a domain-specific conversational interface of the first entity; and
in response to identifying a user interaction from the first user indicating an intent to transfer, transferring the natural language search interaction from the first conversational interface to domain-specific conversational interface associated with the first entity.

19. The computer-implemented method of claim 18, wherein receiving the registration at the first conversational interface comprises:
generating a search configuration profile associated with the first entity, the search configuration profile associated with at least one search result or response and the at least one endpoint associated with the first entity; and
associating at least one of a disclosure, a set of terms and conditions, or a privacy statement with the first entity.

20. The computer-implemented method of claim 19, wherein transferring the natural language search interaction comprises:
obtaining, by the first conversational interface, information from the search configuration profile associated with the first entity based on the at least one identified response;
identifying a set of context associated with the natural language search interaction between the first user and first conversational interface;
generating, by the first conversational interface, a transfer UI, wherein the transfer UI is associated with the transfer of the natural language search interaction from the first conversational interface to domain-specific conversational interface associated with the first entity, and wherein the transfer UI includes at least a portion of the obtained information from the search configuration profile and at least a portion of the identified set of context associated with the natural language search interaction; and
providing for presentation, by the first conversational interface and to the first user, the transfer UI.
